(19) United States
(12) Patent Application Publication
(10) Pub. No.: US 2025/0150256 A1
(43) Pub. Date: May 8, 2025

(54) SERVER DEVICE FOR PROVIDING HOMOMORPHIC ENCRYPTION AI MODEL AND METHOD THEREOF

(71) Applicant: CRYPTO LAB INC., Seoul (KR)

(72) Inventors: Suyeong Park, Seoul (KR); Soo-Heang Eo, Seoul (KR); Garam Lee, Seoul (KR); Sung Hee Hong, Gwangmyeong-si (KR); Sulgi Kim, Seoul (KR)

(21) Appl. No.: 18/934,695

(22) Filed: Nov. 1, 2024

(30) Foreign Application Priority Data
Nov. 2, 2023 (KR) 10-2023-0150206
Oct. 10, 2024 (KR) 10-2024-0137998

(51) Int. Cl. H04L 9/00; G06N 20/00

(52) U.S. Cl. CPC H04L 9/008; G06N 20/00

(57) ABSTRACT

Disclosed is a server device. The device includes: a communicator; a memory; and a processor, wherein the processor is configured to receive a reference artificial intelligence (AI) model of an external device through the communicator and store the received reference AI model in the memory, acquire a plaintext AI model friendly to homomorphic encryption by performing a knowledge distillation task based on the reference AI model for a lightweight AI model designed to operate homomorphic encryption efficiently compared to the reference AI model, and convert the plaintext AI model into a homomorphic encryption AI model by encrypting data used by the plaintext AI model. Accordingly, the device may easily provide the homomorphic encryption AI model.

### CROSS REFERENCE TO PRIOR APPLICATIONS

This application claims priority to and the benefit Korean Patent Application No. 10-2023-0150206 and 10-2024-0137998 filed on Nov. 2, 2023, and Oct. 10, 2024, which are hereby incorporated by reference in their entirety BACKGROUND

### 1. FIELD

The present disclosure relates to a server device for providing a homomorphic encryption artificial intelligence (AI) model and a method thereof.

### 2. DESCRIPTION OF RELATED ART

An artificial intelligence (AI) model is being used in various fields in accordance with the development of artificial intelligence technology. In detail, robot devices that recognize surrounding objects by using the AI model and then performs deliveries, or robot devices that appropriately respond to various inquiries from users, are being used.

In addition, recently, as use of the generative AI model has become popular, the user may input various questions or requests into the AI model and use its responses. Most of these AI models may be held by a server device. Contents of the questions or requests input by the user using his or her computer or mobile phone may be transmitted to the server device. During this process, the user's personal information or confidential content may be transmitted to the server device.

The conventional AI model may receive various questions or requests in a plaintext and transmit the corresponding response also in the plaintext. Therefore, the contents of questions or responses may be easily leaked by an administrator of the server device or another third party.

Accordingly, there is an emerging need for the homomorphic encryption AI model that may respond to the questions in the form of homomorphic encryption. However, a task of converting the plaintext AI model into the homomorphic encryption AI model is by no means easy, considering an amount of computation required.

### SUMMARY

The present disclosure provides a device for converting a plaintext artificial intelligence (AI) model into a homomorphic encryption AI model, and a method thereof.

According to at least one embodiment of the present disclosure, provided is a server device including: a communicator; a memory; and a processor, wherein the processor is configured to receive a reference artificial intelligence (AI) model of an external device through the communicator and store the received reference AI model in the memory, acquire a plaintext AI model friendly to homomorphic encryption by performing a knowledge distillation task based on the reference AI model for a lightweight AI model compared to the reference AI model, and convert the plaintext AI model into a homomorphic encryption AI model by encrypting data used by the plaintext AI model.

According to at least one embodiment of the present disclosure, provided is a method of a server device for providing a homomorphic encryption artificial intelligence (AI) model, the method including: receiving and storing a reference AI model of an external device; acquiring a plaintext AI model friendly to homomorphic encryption by performing a knowledge distillation task based on the reference AI model for a lightweight AI model designed to operate homomorphic encryption efficiently compared to the reference AI model; and converting the plaintext AI model into a homomorphic encryption AI model that can be operated using the homomorphic encryption by encrypting data used by the plaintext AI model.

According to the various embodiments as described above, the plaintext AI model may be easily converted into the homomorphic encryption AI model.

### BRIEF DESCRIPTION OF THE DRAWINGS

FIG. 1 is a diagram for describing an operation of a server device according to at least one embodiment of the present disclosure;

FIG. 2 is a block diagram showing a configuration of the server device according to at least one embodiment of the present disclosure;

FIG. 3 is a diagram for describing a process of providing a plaintext artificial intelligence (AI) model friendly to homomorphic encryption by using a reference AI model;

FIG. 4 is a diagram for describing a process of converting the plaintext AI model friendly to homomorphic encryption into the homomorphic encryption AI model;

FIG. 5 is a diagram for describing a method of providing an AI model for password strength testing;

FIG. 6 is a diagram for describing a method for using the homomorphic encryption AI model that is provided using the method in FIG. 5; and

FIG. 7 is a flow chart for describing a method for providing a homomorphic encryption artificial intelligence (AI) model according to at least one embodiment of the present disclosure.

### DETAILED DESCRIPTION

Encryption/decryption may be applied as necessary to a process of transmitting information (or data) that is performed in the specification, and an expression describing the process of transmitting the information (or data) in the specification and the claims should be interpreted as also including all cases of the encryption/decryption even if not separately mentioned. In the present disclosure, an expression such as “transmission (transfer) from A to B” or “reception from A to B” may include transmission (transfer) or reception while having another medium included in the middle, and may not necessarily express only the direct transmission (transfer) or reception from A to B.

In describing the present disclosure, a sequence of each operation should be understood as non-restrictive unless a preceding operation in the sequence of each operation needs to logically and temporally precede a subsequent operation. That is, except for the above exceptional case, the essence of the present disclosure is not affected even if a process described as the subsequent operation is performed before a process described as the preceding operation, and the scope of the present disclosure should also be defined regardless of the sequences of the operations. In addition, in the specification, “A or B” may be defined to indicate not only selectively indicating either one of A and B, but also including both A and B. In addition, a term “including” in the specification may have a meaning encompassing further including other components in addition to components listed as being included.

The present disclosure only describes essential components necessary for describing the present disclosure, and does not mention components unrelated to the essence of the present disclosure. In addition, it should not be interpreted as an exclusive meaning that the present disclosure includes only the mentioned components, and should be interpreted as a non-exclusive meaning that the present disclosure may include other components as well.

In addition, in the specification, a “value” may be defined as a concept that includes a vector as well as a scalar value.

Mathematical operations and calculations in each step of the present disclosure described below may be implemented as computer operations by a known coding method and/or coding designed to be suitable for the present disclosure to perform the corresponding operations or calculations.

Specific equations described below are exemplarily described among possible alternatives, and the scope of the present disclosure should not be construed as being limited to the equations mentioned in the present disclosure.

For convenience of description, the present disclosure defines the following notations:
a←D: Select an element a based on distribution D.
s1, s2ϵR: Each of S1 and S2 is an element belonging to a set R.
mod(q): Perform modular operation with an element q.
[symbol] : Round an internal value.

Hereinafter, various embodiments of the present disclosure are described in detail with reference to the accompanying drawings.

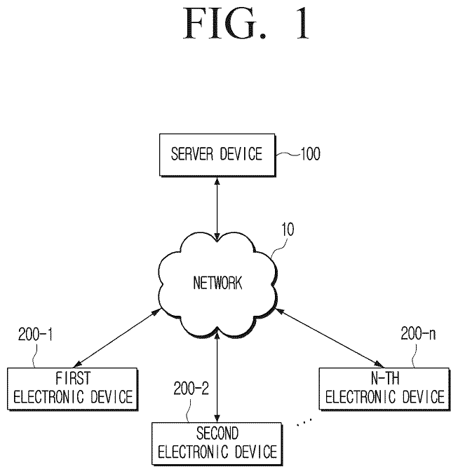

FIG. 1 is a diagram for describing an operation of a server device according to at least one embodiment of the present disclosure. Referring to FIG. 1, a server device 100 and a plurality of electronic devices 200-1 to 200-n may be connected to each other through a network 10.

The networks 10 may be implemented in various types of wired and wireless communication networks, broadcast communication networks, optical communication networks, cloud networks, and the like. FIG. 1 shows that the respective devices 100 and 200-1 to 200-n are indirectly connected to one another through the network 10, the devices are not limited thereto, and the respective devices 100 and 200-1 to 200-n may be connected to one another through wireless fidelity (WiFi), Bluetooth, near field communication (NFC), or the like without any separate medium.

The server device 100 shown in FIG. 1 may be a device for providing a homomorphic encryption artificial intelligence (AI) model. The server device 100 may be implemented as one electronic device or as a cloud server. In addition, the server device 100 may be implemented as a web server accessible through the network 10, such as the Internet. FIG. 1 shows the server device 100 to distinguish the corresponding device from the electronic devices 200-1 to 200-n. However, the server device 100 may also be alternatively described as the electronic device. In this case, the other electronic devices 200-1 to 200-n may be described as external devices.

The electronic devices 200-1 to 200-n may be various terminal devices used by various users. In detail, the electronic devices 200-1 to 200-n may be implemented in various forms such as personal computers (PCs), laptop PCs, mobile phones, tablet PCs, and the like. Alternatively, the electronic devices 200-1 to 200-n may be other server devices that use the AI model.

The AI model is used for various purposes in accordance with the development of electronic technology. For example, at least one of the electronic devices 200-1 to 200-n may use the AI model to examine security level of a password if the user wants to set the password. Alternatively, at least one of the electronic devices 200-1 to 200-n may use the AI model to collect and provide personal information corresponding to a user request among personal information of residents residing in a specific area.

These various AI models may be trained in the form of a plaintext. However, in this case, there is a high risk that content requested by the user and content of a response from the AI model are leaked to the outside. Accordingly, the electronic devices 200-1 to 200-n may request the server device 100 to convert the AI model that the electronic devices 200-1 to 200-n want to use into the homomorphic encryption AI model.

The server device 100 may reply to each request from the electronic devices 200-1 to 200-n by converting the plaintext AI model into the homomorphic encryption AI model. Alternatively, the server device 100 may store the converted homomorphic encryption AI model on its own, and provide a service that receives the request from each of the electronic devices 200-1 to 200-n and processes the request by using the homomorphic encryption AI model.

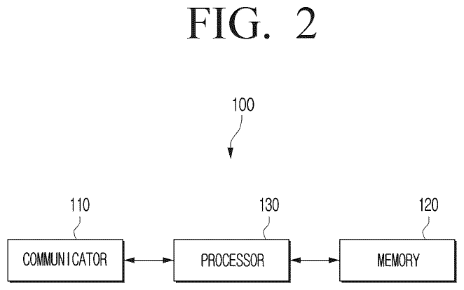

FIG. 2 is a block diagram showing a configuration of the server device according to at least one embodiment of the present disclosure. Referring to FIG. 2, the server device 100 may include a communicator 110, a memory 120, and a processor 130.

The communicator 110 may be a component for communicating with various external devices including the electronic devices 200-1 to 200-n. The communicator 110 may transmit and receive various signals and data to the external device by using various wired and wireless communication methods such as a wired/wireless local area network (LAN), a wide area network (WAN), an Ethernet, an IEEE 1394, a Bluetooth, an access point (AP) based wireless fidelity (WiFi, i.e., wireless local area network (LAN)), a Zigbee, a high definition multimedia interface (HDMI), a universal serial bus (USB), a mobile high-definition link (MHL), an audio engineering society/European broadcasting union (AES/EBU) communication, an optical communication, and a coaxial communication. For example, the communicator 110 may receive a query from each of the electronic devices 200-1 to 200-n in FIG. 1.

The memory 120 may be a component for storing various programs, data, instructions, or the like required for an operation of the server device 100. The memory 120 may be implemented as at least one of various memories such as a dynamic random access memory (DRAM), a static RAM (SRAM), a synchronous dynamic RAM (SDRAM), an one time programmable read only memory (OTPROM), a programmable ROM (PROM), an erasable and programmable ROM (EPROM), an electrically erasable and programmable ROM (EEPROM), a mask ROM, a flash ROM, a flash memory, a hard drive, and a solid state drive (SSD).

The memory 120 may store at least one AI model, data or programs for training the AI model, or the like. The present disclosure describes a case where the AI model is directly stored in the memory 120, and is not limited thereto. The AI model may be stored in the external device rather than the server device 100, in which case the server device 100 may access the AI model of the external device through the communicator 110.

The processor 130 may be a component for controlling overall operations of the server device 100. The processor 130 may perform various operations based on the instructions, programs, data, or the like stored in the memory 120.

The processor 130 may be implemented as a digital signal processor (DSP) or a microprocessor that processes a digital signal. However, the processor 130 is not limited thereto, may include at least one of a central processing unit (CPU), a micro controller unit (MCU), a micro processing unit (MPU), a controller, an application processor (AP), a communication processor (CP), or an advanced RISC machine (ARM) processor, a graphic processing unit (GPU), a neural processing unit (NPU), an artificial intelligence (AI) processor, or may be defined by the corresponding term. In addition, the processor 130 may be implemented in a system-on-chip (SoC) or a large scale integration (LSI), in which a processing algorithm is embedded, or may be implemented in the form of a field programmable gate array (FPGA).

The CPU is the general-purpose processor which may perform not only a general operation but also an artificial intelligence operation, and may efficiently execute complex programs through a multi-layered cache structure. The CPU may be advantageous for a serial processing method that enables organic linkage between a previous calculation result and a next calculation result through sequential calculations.

The GPU is the processor for large-scale operations such as floating-point operations used for graphics processing, and may perform the large-scale operations in parallel by integrating a large number of cores. In particular, the GPU may be advantageous for a parallel processing method such as a convolution operation or the like compared to the CPU. In addition, the GPU may be used as a co-processor to supplement the function of the CPU.

The NPU is the processor specialized in the AI operation using an artificial neural network, and each layer included in the artificial neural network may be implemented in hardware (e.g., silicon). Here, the NPU is specially designed based on requirements of a company, and may thus have a lower degree of freedom than the CPU or the GPU. However, the NPU may efficiently process the AI operation required by the company. Meanwhile, as the processor specialized for the AI operation, the NPU may be implemented in any of various forms such as a tensor processing unit (TPU), an intelligence processing unit (IPU), and a vision processing unit (VPU). The AI processor is not limited to the above example unless specified as the above-mentioned NPU.

In addition, the processor 130 may be implemented in the system-on-chip (SoC). Here, the SoC may further include the memory 120 and a network interface such as a bus for data communication between the processor 130 and the memory 120 in addition to one or more processors 130.

If the plurality of processors 130 are included in one SoC, the server device 100 may perform an operation related to the AI (for example, an operation related to training or inference of the AI model) using some of the processors 130 among the plurality of processors 130. For example, the server device 100 may perform the operation related to the AI by using at least one of the GPU, NPU, VPU, TPU, or a hardware accelerator that is specialized for the AI operation such as the convolution operation or a matrix multiplication operation among the plurality of processors 130. However, this configuration is only an example, and the server device 100 may process the operation related to the AI by using the general-purpose processor 130 such as the CPU.

In addition, the server device 100 may perform an operation for a function related to the AI by using multi-cores (e.g., dual-core or quad-core) included in one processor 130. In particular, the server device 100 may perform the AI operation such as the convolution operation or the matrix multiplication operation in parallel by using the multi-core included in the processor 130.

One or more processors 130 may perform the control to process input data according to a predefined operation rule or the AI model stored in the memory 120. The predefined operation rule or the AI model may be provided by the learning.

Here, being provided through the learning indicates that the predefined operation rule or AI model of a desired feature is provided by applying a learning algorithm to a large number of learning data. Such learning may be performed by a device itself in which the AI is performed according to the present disclosure, or may be performed by a separate server/system.

The AI model may include the plurality of neural network layers. At least one layer may have at least one weight value, and perform a layer operation through an operation result of a previous layer and at least one defined operation. The neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), a deep Q-network, or a transformer. However, the neural network of the present disclosure is not limited to the above examples unless otherwise specified.

The learning algorithm is a method of training a predetermined target device (e.g., robot) by using a large number of learning data for the predetermined target device to make a decision or a prediction for itself. The learning algorithm may include, for example, a supervised learning algorithm, an unsupervised learning algorithm, a semi-supervised learning algorithm, or a reinforcement learning algorithm. However, the learning algorithm of the present disclosure is not limited to the above-described examples unless specified otherwise.

Meanwhile, as described above, the processor 130 may store the AI model to be converted in the memory 120 if a model conversion request is received from each of the electronic devices 200-1 to 200-n. For example, the processor 130 may receive the AI model of the external devices, i.e., the electronic devices 200-1 to 200-n, through the communicator 110, and store the received reference AI model in the memory 120. For convenience of description, this AI model may be described in any of various ways, such as a reference AI model, a teacher model, a master model, a large-scale model, or a heavyweight model, but may be described as the reference AI model hereinafter. That is, the reference AI model may be the plaintext model that is pre-trained to perform a task predetermined by the external device.

The processor 130 may perform an operation of converting the reference AI model into the plaintext AI model friendly to homomorphic encryption. For example, the processor 130 may provide the plaintext AI model friendly to homomorphic encryption by selecting a lightweight AI model that performs an operation similar to or identical to the reference AI model among the plurality of pre-stored plaintext AI models, and then performing a knowledge distillation operation based on the reference AI model.

The processor 130 may convert the plaintext AI model into the homomorphic encryption AI model by encrypting data used in the provided plaintext AI model.

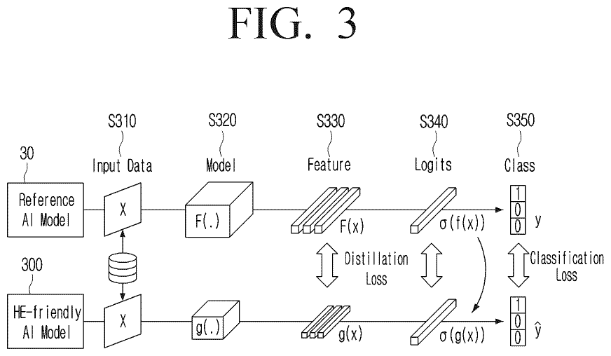

FIG. 3 is a diagram for describing a process of providing the plaintext AI model friendly to the homomorphic encryption by using the reference AI model.

Referring to FIG. 3, the processor 130 may input the same data to a reference AI model 30 and a plaintext AI model 300 (S310). In detail, the plaintext AI model 300 may be a model having a reduced number of layers or parameters compared to the reference AI model 30, a model having an optimized input distribution, a polynomial neural network, or the like. Here, the model having the optimized input distribution may indicate a model having an input distribution which is pre-calculated to thus be reduced to the maximum compared to the reference AI model and easily performing the operation in a homomorphic encryption state. For example, if the reference AI model 30 is a Bert model having 24 layers, the model reduced to 6 layers may be selected as the plaintext AI model 300. The plaintext AI model 300 may also be referred to as a homomorphic encryption (HE)-friendly AI model.

Each of the reference AI model 30 and the plaintext AI model 300 may output an output value corresponding to the input data (S320). In FIG. 3, x indicates input data, f( ) indicates the reference AI model 30, g( ) indicates the plaintext AI model 300 to be trained, and σ( ) indicates a softmax function.

The processor 130 may sequentially acquire feature values (f(x), g(x)), logits (σ(f(x)), σ(g(x))), class values, and the like from the output value (S330, S340, and S350), acquires a distillation loss by comparing these values with one other, and feed back the acquired distillation loss to the lightweight AI model, that is, the plaintext AI model 300.

The feature value in FIG. 3 may have the form of an embedding vector. The processor 130 may perform the optimization to reduce a total loss, which is a weighted sum of a classification loss and the distillation loss. The processor 130 may perform these operations multiple times to train the plaintext AI model 300 to output the output value that is almost similar to the reference AI model 30.

In FIG. 3, a cross entropy loss and the total loss may be expressed as follows.

$$Cross Entropy Loss : {Loss}_{CE} ( X , Y ) = - {\sum }_{i = 1}^{C} {x}_{i} log {y}_{i} \qquad [ Equation 1 ]$$

$$Total Loss = {Loss}_{CE} ( σ ( f ( x ) ) , \hat{y} ) + 2 λ {Loss}_{CE} ( σ ( f ( x ) / T ) , σ ( g ( x ) / T ) )$$

FIG. 3 shows and describes a case where the feature values, the logits, and the class values are respectively acquired from the reference AI model 30 and the plaintext AI model 300 and compared with one another. However, in some embodiments, only some of these values may be compared with one another to maximize performances of the AI models.

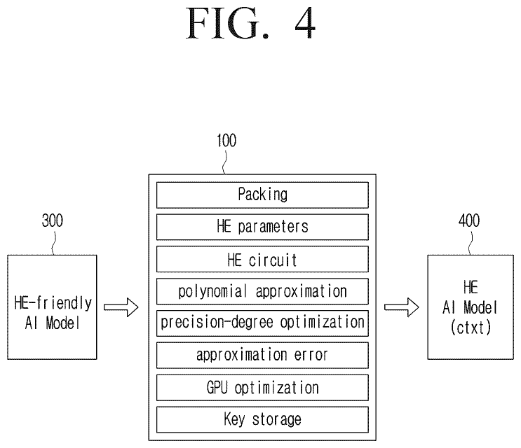

FIG. 4 is a diagram for describing a process of converting the plaintext AI model friendly to homomorphic encryption into the homomorphic encryption AI model.

Referring to FIG. 4, the processor 130 may perform a plurality of operations on the homomorphic encryption (HE)-friendly AI model 300 and convert the AI model 300 into a homomorphic encryption AI model 400. Referring to FIG. 4, the processor 130 may convert the plaintext AI model into the homomorphic encryption model by performing the followings at minimum, sequentially, individually, or in parallel: a task of defining at least one parameter used by the homomorphic encryption AI model 400 (HE parameter), a packing task of merging data used by the plaintext AI model 300 into an encrypted form (packing), a task of determining the type, order, number of times, and structure of an operation performed by the homomorphic encryption AI model (HE circuit), a task of securing a storage(key storage) for storing at least one key used for the homomorphic encryption and ciphertext, a polynomial approximation task of approximating a nonlinear operation into a polynomial (polynomial approximation), a task of adjusting a trade-off relationship between the degree and precision of each polynomial used in the polynomial approximation task (precision-degree optimization), a task of adjusting the input distribution of a function used in the polynomial approximation task, a task of adjusting an approximation error in a process of operating the polynomial (approximation error), and a task of adjusting a homomorphic encryption operation to be performed by the GPU (GPU optimization).

Here, the parameter describes an underlying space of the homomorphic encrypted ciphertext, which may include a key size, a size of a plaintext space, a noise level of the homomorphic encryption, or the like. The parameter may be pre-defined and stored before providing the key for the homomorphic encryption and decryption.

The operation performed by the homomorphic encryption AI model may indicate an operation performed on encrypted data. In general, the operation may include a combination of addition or multiplication. A bootstrapping location, an operation depth, or the like may be determined in the task of determining the type, order, number of times, and structure of the operation (HE circuit).

The polynomial approximation task may be a task of approximating the nonlinear operation that is difficult to be operated in a homomorphic encryption method into a polynomial that is easily calculated using the homomorphic encryption. That is, if the reference AI model includes a large number of these nonlinear operations, it may be difficult to output a precise result in case that the corresponding AI model is converted into the homomorphic encryption AI model because the operation may not be performed properly. To prevent this problem, the nonlinear operation in the reference AI model may be approximated into the polynomial in advance. For example, if a sigmoid function is converted into the polynomial by using a Taylor function, the sigmoid function may be processed as in the following equation.

$$σ ( x ) = \frac{1}{1 + exp ( - x )} σ ( x ) = \frac{1}{2} + \frac{1}{4} x - \frac{1}{48} {x}^{3} + \frac{1}{480} {x}^{5} - \frac{17}{80640} {x}^{7} + \frac{31}{1451520} {x}^{9} + O ( {x}^{11} ) \qquad [ Equation 2 ]$$

The precision-degree optimization task may be a task of optimizing the trade-off relationship between the degree of the polynomial and the precision of the polynomial in a polynomial approximation process. In the sigmoid function described above, as the degree of the polynomial is increased, a difference in precision between the sigmoid and the polynomial may be increased, but a calculation speed may become very slow. Therefore, speed and precision may be adjusted by appropriately adjusting this relationship.

The task of adjusting the input distribution may indicate a task of optimizing the input distribution. In case of approximating the polynomial function, it needs to know the input distribution of the function to approximate the polynomial, and it may thus be required to first investigate the input distribution. For example, in the above sigmoid function example, the sigmoid function may have an input distribution (input range) of [−8, 8], and the degree of the polynomial may be 9 if optimally determined by considering the trade-off. However, if the approximated sigmoid function encounters a value outside this range, the value may greatly differ from the value of the original sigmoid function, which may significantly degrade the accuracy of the AI model. Therefore, to prevent the performance of the AI model from being degraded, the input distribution may be adjusted to fit within the above-described range or the polynomial function may be approximated by adjusting the input distribution through fine adjustment.

The processor 130 may provide the homomorphic encryption AI model 400 by performing these tasks.

As described above, the server device 100 may convert the various reference AI models for performing various operations into the homomorphic encryption AI model in the same manner as described above.

As one of the reference AI models, the server device 100 may convert the AI model for password strength testing into the homomorphic encryption AI model.

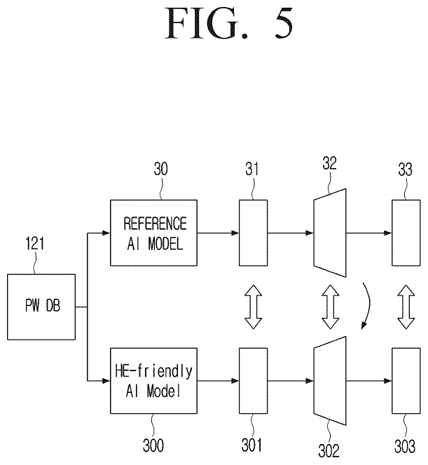

FIG. 5 is a diagram for describing a method of providing the AI model for password strength testing. A third party may easily hack the following passwords: the password having a hacking history, the password that is the same as the password that the user used before, the password related to the user's personal information such as the user's resident registration number or birthday, the password including a simple list of numbers or letters such as 1111 or 2222. Therefore, the AI model may be used to diagnose whether the password is safe enough in security or whether the password has such a history.

Referring to 5, the description describes a case of training the AI model to check whether the password is safe in security not to be too simple or hacked.

Referring to FIG. 5, the processor 130 may input every password of a database 121 that records an unusable password into each of the reference AI model 30 and the HE-friendly AI model 300. The AI model 30 or 300 may output a result value for the input password by using a plurality of layers 31, 32, and 33 or 301, 302, and 303. The processor 130 may improve the performance by comparing the output result values for each layer and feeding a difference value as a loss for backpropagation to the HE-friendly AI model 300. The processor 130 may perform this operation repeatedly until the difference value is less than a predetermined threshold value.

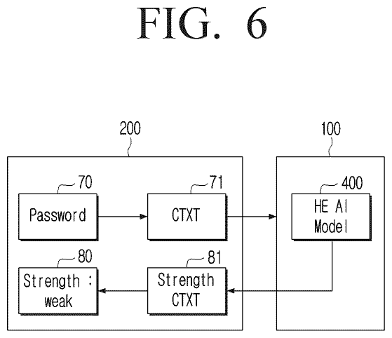

FIG. 6 is a diagram for describing a method for using the homomorphic encryption AI model that is provided based on the plaintext AI model trained in the same manner as shown in FIG. 5.

Referring to FIG. 6, the user may input a password 70 to be diagnosed into the electronic device 200. The electronic device 200 may include the processor and the memory (not shown) for performing the homomorphic encryption and the communicator for transmitting the homomorphic encrypted ciphertext to the outside. The electronic device 200 may be one of a number of the electronic devices shown in FIG. 1.

The electronic device 200 may provide homomorphic encrypted ciphertext 71 by homomorphically encrypting the input password 70.

The electronic device 200 may provide a public key, a secret key, and an operation key for the homomorphic encryption and store the same in the memory.

The public key may be a key used to perform the homomorphic encryption, and the secret key may be a key used to decrypt the homomorphic encrypted ciphertext. The operation key may be a key used for various operations (evaluation or computation) based on the homomorphic encrypted ciphertext. In detail, the operation key may include a relinearization key rlk, a rotation key rotKey, or the like. The relinearization key may be used for a multiplication operation, and the rotation key may be used for a rotation operation.

As an example, the electronic device 200 may generate the public key by using a Ring-LWE technique. To describe in detail, the electronic device 200 may first set various parameters and rings, and store the same in the memory. The parameter may include, for example, a length of a plaintext message bit, a size of the public key, a size of the secret key, or the like.

The ring may be expressed by the following equation.

$$R = {Z}_{q} [ X ] / f ( x ) . \qquad [ Equation 3 ]$$

Here, R indicates the ring, Z_{q} indicates a coefficient, and f(x) indicates an N-th polynomial.

The ring indicates a set of polynomials having predetermined coefficients, and indicates a set in which addition and multiplication are defined between elements and which is closed under the addition and the multiplication.

As an example, the ring R indicates a set of the N-th polynomials having the coefficient Z_{q}. In detail, if n is Φ(N), N indicates a polynomial which may be calculated as the remainder of dividing the polynomial by an N-th cyclotomic polynomial.

In Equation 1, (f(x)) indicates ideal of Z_{q}[x] generated by f(x). The Euler totient function Φ(N) indicates the number of natural numbers that are coprime to N and smaller than N. If Φ_{N}(x) is defined as the n-th cyclotomic polynomial, the ring may also be expressed by Equation 4 as follows.

$$R = {Z}_{q} [ X ] / {Φ}_{N} ( x ) . \qquad [ Equation 4 ]$$

Meanwhile, the ring R in Equation 4 described above may have binary data in the plain text space. If the ring is set in this way, the electronic device 200 may calculate a secret key sk from the ring. The secret key sk may be expressed as follows.

$$sk ← ( 1 , s ( x ) ) , s ( x ) ¡ \hat{o} R . \qquad [ Equation 5 ]$$

Here, s(x) indicates a random polynomial generated using a small coefficient.

In addition, the electronic device 200 may calculate a first random polynomial a(x) from the ring. The first random polynomial may be expressed as follows.

$$a ( x ) ← R . \qquad [ Equation 6 ]$$

In addition, the electronic device 200 may calculate an error. In detail, the electronic device 200 may extract the error from a discrete Gaussian distribution or a distribution having a statistical distance close thereto. This error may be expressed as follows.

$$e ( x ) ← {D}_{α q}^{n} . \qquad [ Equation 7 ]$$

If even the error is calculated, the electronic device 200 may calculate a second random polynomial by performing modular operations on the errors in the first random polynomial and the secret key. The second random polynomial may be expressed as follows.

$$b ( x ) = - a ( x ) s ( x ) + e ( x ) ( mod q ) . \qquad [ Equation 8 ]$$

Finally, a public key pk may be set to include the first random polynomial and the second random polynomial as follows.

$$pk = ( b ( x ) , a ( x ) ) . \qquad [ Equation 9 ]$$

The method for providing a key described above is only an example, and is not necessarily limited thereto. The electronic device 200 may provide various keys by using other methods.

The electronic device 200 may store information on the keys generated for the homomorphic encryption in the memory. The electronic device 200 may transmit the public key, the operation key, and the like for the encryption among these keys to the server device 100 together with the homomorphic encrypted ciphertext 71.

The server device 100 may acquire the result value by inputting the homomorphic encrypted ciphertext 71 into the homomorphic encryption AI model provided in the manner described above. The input data may be the homomorphic encrypted ciphertext 71 and the operation may also be performed in the encryption state, and the output result value may thus also have the form of the homomorphic encrypted ciphertext. The server device 100 may transmit a result value 81 to the electronic device 200. The electronic device 200 may decode the result value 81 by using the secret key and check a diagnosis result 80 of the password input by the electronic device 200.

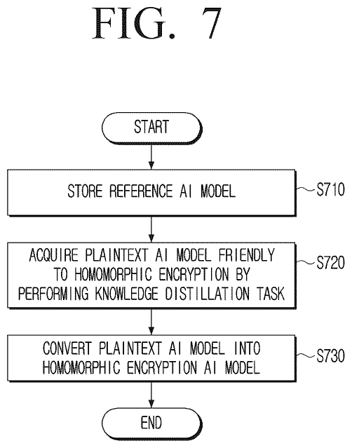

FIG. 7 is a flow chart for describing a method for providing the homomorphic AI model according to at least one embodiment of the present disclosure.

Referring to FIG. 7, the server device may receive and store the reference AI model of the external device (S710). The server device may acquire the plaintext AI model friendly to the homomorphic encryption by selecting the lightweight AI model compared to the reference AI model and performing a knowledge distillation task based on the reference AI model to thus train the lightweight AI model to be operated similarly to the reference AI model (S720).

The server device may then acquire the homomorphic encryption AI model, which is converted from the plaintext AI model to able to perform the homomorphic encryption operation, by encrypting the data used by the plaintext AI model (S730).

The description describes the acquiring of the plaintext AI model and the converting of the homomorphic encryption AI model in detail in the other embodiments described above, and thus omits their redundant descriptions.

A method for diagnosing a password in FIG. 7 may be performed by the server device having the configuration shown in FIG. 2, is not necessarily limited thereto, and may also be performed by the electronic device having various configurations.

The contents in the various embodiments described above may be implemented independently for each embodiment, or may be implemented in combination with at least some of the other embodiments of the present disclosure.

In addition, the various embodiments of the present disclosure described above may be implemented by software including an instruction stored in a machine-readable storage medium (for example, a computer readable storage medium). A machine may be a device that invokes the stored instruction from a storage medium, may be operated based on the invoked instruction, and may include the server device according to the disclosed embodiments. If the instruction is executed by the processor, the processor may directly perform a function corresponding to the instruction, or other components may perform the function corresponding to the instruction under a control of the processor. The instruction may include a code provided or executed by a compiler or an interpreter. The machine-readable storage medium may be provided in the form of a non-transitory storage medium. Here, the term “non-transitory” indicates that the storage medium is tangible without including a signal, and does not distinguish whether data are semi-permanently or temporarily stored in the storage medium.

In addition, the methods according to the various embodiments described above may be included and provided in a computer program product. The computer program product may be traded as a product between a seller and a purchaser. The computer program product may be distributed in the form of a storage medium (for example, a compact disc read only memory (CD-ROM)) that may be read by the machine or online through an application store. In case of the online distribution, at least a part of the computer program product may be at least temporarily stored in the storage medium such as a memory included in a server of a manufacturer, a server of an application store or a relay server, or be temporarily provided.

Each of the components (for example, modules or programs) according to the various embodiments described above may include one entity or a plurality of entities, and some of the corresponding sub-components described above may be omitted or other sub-components may be further included in the various embodiments. Alternatively or additionally, some of the components (e.g., modules or programs) may be integrated into one entity, and may perform functions performed by the respective corresponding components before being integrated in the same or similar manner. Operations performed by the modules, the programs, or other components according to the various embodiments may be executed in a sequential manner, a parallel manner, an iterative manner or a heuristic manner, at least some of the operations may be performed in a different order or be omitted, or other operations may be added.

Although the embodiments are shown and described in the present disclosure as above, the present disclosure is not limited to the above-mentioned specific embodiments, and may be variously modified by those skilled in the art to which the present disclosure pertains without departing from the gist of the present disclosure as claimed in the accompanying claims. These modifications should also be understood to fall within the scope and spirit of the present disclosure.

What is claimed is:

1. A server device comprising:
a communicator;
a memory; and
a processor,
wherein the processor is configured to
receive a reference artificial intelligence (AI) model of an external device through the communicator and store the received reference AI model in the memory,
acquire a plaintext AI model friendly to homomorphic encryption by performing a knowledge distillation task based on the reference AI model for a lightweight AI model designed to operate homomorphic encryption efficiently compared to the reference AI model, and
convert the plaintext AI model into a homomorphic encryption AI model by encrypting data used by the plaintext AI model.

2. The device as claimed in claim 1, wherein the processor is configured to
input the same learning data to the reference AI model and the lightweight AI model,
acquire a distillation loss by comparing at least one of embedding vectors, logits, or class values, respectively output from the reference AI model and the lightweight AI model, and
acquire the plaintext AI model by a training process, feeding back the distillation loss to the lightweight AI model multiple times.

3. The device as claimed in claim 2,
wherein the reference AI model is the plaintext model that is pre-trained to perform a task predetermined by the external device, and
wherein the lightweight AI model is the plaintext model which includes one of a model having a reduced number of layers or parameters compared to the reference AI model and easily performing an operation in a homomorphic encryption state, a model having a optimized input distribution compared to the reference AI model, or a polynomial neural network.

4. The device as claimed in claim 1, wherein the processor is configured to convert the plaintext AI model into the homomorphic encryption AI model by performing:
a task of defining at least one parameter used by the homomorphic encryption AI model,
a packing task of merging the data used by the plaintext AI model into an encrypted form,
a task of determining the type, order, number of times, and structure of an operation performed by the homomorphic encryption AI model,
a task of securing a storage for storing at least one key used for the homomorphic encryption and ciphertext,
a polynomial approximation task of approximating a nonlinear operation into a polynomial,
a task of adjusting a trade-off relationship between the degree and precision of each polynomial used in the polynomial approximation task,
a task of adjusting an input distribution of a function used in the polynomial approximation task,
a task of adjusting an approximation error in a process of operating the polynomial, and
a task of adjusting a homomorphic encryption operation to be performed by a graphic processing unit (GPU).

5. A method of a server device for providing a homomorphic encryption artificial intelligence (AI) model, the method comprising:
receiving and storing a reference AI model of an external device;
acquiring a plaintext AI model friendly to homomorphic encryption by performing a knowledge distillation task based on the reference AI model for a lightweight AI model designed to operate homomorphic encryption efficiently compared to the reference AI model; and
converting the plaintext AI model into a homomorphic encryption AI model by encrypting data used by the plaintext AI model.

6. The method as claimed in claim 5, wherein the acquiring of the plaintext AI model friendly to homomorphic encryption includes
inputting the same learning data to the reference AI model and the lightweight AI model,
acquiring a distillation loss by comparing at least one of embedding vectors, logits, or class values, respectively output from the reference AI model and the lightweight AI model, and
acquiring the plaintext AI model by a training process, feeding back the distillation loss to the lightweight AI model multiple times.

7. The method as claimed in claim 6,
wherein the reference AI model is the plaintext model that is pre-trained to perform a task predetermined by the external device, and
the lightweight AI model is the plaintext model which includes one of a model having a reduced number of layers or parameters compared to the reference AI model, a model having a optimized input distribution compared to the reference AI model, or a polynomial neural network.

8. The method as claimed in claim 7, wherein in the converting of the plaintext AI model into the homomorphic encryption AI model,
the plaintext AI model is converted into the homomorphic encryption AI model by performing:
a task of defining at least one parameter used by the homomorphic encryption AI model,
a packing task of merging the data used by the plaintext AI model into an encrypted form,
a task of determining the type, order, number of times, and structure of an operation performed by the homomorphic encryption AI model,
a task of securing a storage for storing at least one key used for the homomorphic encryption and ciphertext,
a polynomial approximation task of approximating a nonlinear operation into a polynomial,
a task of adjusting a trade-off relationship between the degree and precision of each polynomial used in the polynomial approximation task,
a task of adjusting an input distribution of a function used in the polynomial approximation task,
a task of adjusting an approximation error in a process of operating the polynomial, and
a task of adjusting a homomorphic encryption operation to be performed by a graphic processing unit (GPU).
